(19) United States
(12) Patent Application Publication
(10) Pub. No.: US 2017/0018817 A1
(43) Pub. Date: Jan. 19, 2017

(54) METHOD, SYSTEM, AND APPARATUS FOR INHIBITING THERMAL RUNAWAY OF A BATTERY CELL

(71) Applicant: CORVUS ENERGY LTD., Richmond, CA (US)

(72) Inventors: Stewart Neil SIMMONDS, Richmond (CA); Johannes Christian KRUGER, Richmond (CA)

(21) Appl. No.: 15/301,238

(22) PCT Filed: Apr. 2, 2015
(86) PCT No.: PCT/CA2015/050275

§ 371 Date: Sep. 30, 2016

Related U.S. Application Data
(60) Provisional application No. 61/974,316, filed on Apr. 2, 2014.

(51) Int. Cl. H01M 10/44; H02J 7/00; H01M 10/42; H01M 10/0525; H01M 10/48

(52) U.S. Cl. CPC H01M 10/443; H01M 10/0525; H01M 10/486; H01M 10/425; H02J 7/0029

(57) ABSTRACT

An apparatus for inhibiting thermal runaway of a battery cell uses a temperature sensor to measure a temperature of the cell and a discharge circuit, electrically coupled in series across terminals of the cell, to discharge the cell when its temperature exceeds a maximum normal operating temperature. The discharge circuit includes a switch and a resistive load. The apparatus may be part of a larger system that uses a processor to implement a method to discharge the cell to varying degrees in response to the degree of overheating the cell experiences.

### TECHNICAL FIELD

The present disclosure is directed at a method, system, and apparatus for inhibiting thermal runaway of a battery cell.

### BACKGROUND

Thermal runaway of a battery cell refers to a positive feedback process by which the temperature of the battery cell increases as a result of an exothermic reaction. The exothermic reaction may, for example, result from discharging excessive current from the battery cell or from operating the battery cell in an excessively hot environment. Eventually, uncontrolled thermal runaway causes one or both of the battery cell's temperature and pressure to increase to the extent that the battery cell may combust, explode, or both.

FIG. 1 is a graph 10 showing two curves: one curve shows temperature of a lithium ion 18650 battery cell vs. time (“temperature curve 12”), while another curve shows heating rate of that lithium ion battery cell vs. time (“heating rate curve 14”). In FIG. 1, an external heating source is used to heat the battery cell until its temperature is approximately 85° C., at which temperature the battery cell's solid electrolyte layer melts and the battery cell consequently experiences an internal short circuit. The short-circuit causes the battery cell to begin self-heating, which is the beginning of thermal runaway; that is, the short-circuit begins a self-reinforcing exothermic reaction that causes the battery cell to heat to a temperature that exceeds the temperature that would result from the battery cell's being heated by the external heating source alone (the point on the temperature curve 12 corresponding to 85° C. is hereinafter the “self-heating point 16”, and the temperature at which self-heating occurs is hereinafter the “self-heating temperature”). In FIG. 1, the temperature curve 12 increases relatively linearly and slowly from the self-heating point 16 for a duration of roughly 800 to 900 minutes until it begins to climb exponentially, reaching a peak of approximately 260° C., which reflects the battery cell's having experienced thermal runaway (the point on the temperature curve 12 where the temperature curve 12 first reaches 260° C. is hereinafter the “thermal runaway end point 18”, and the peak temperature resulting from thermal runaway is hereinafter the “thermal runaway peak temperature”). The heating rate curve 14, which is relatively linear before the self-heating point 16 and for most of the period between the self-heating point 16 and the thermal runaway end point 18, similarly increases exponentially shortly before the thermal runaway end point 18.

The pressure inside the battery cell also increases as the battery cell experiences thermal runaway. At its peak, slightly before the thermal runaway end point 18, this pressure is approximately 64 bar. Accordingly, at the thermal runaway end point 18, the battery cell is prone to one or both of explosion and combustion. In an effort to prevent these undesirable outcomes, research and development continue into methods, systems, and apparatuses to inhibit thermal runaway.

### SUMMARY

According to a first aspect, there is provided an apparatus for inhibiting thermal runaway of a battery cell, the apparatus comprising a temperature sensor positioned to measure a temperature of the cell; and a discharge circuit, comprising a switch and a resistive load electrically coupled in series across terminals of the cell, wherein the switch is closed when the temperature sensor detects that the temperature of the cell has exceeded a maximum normal operating temperature.

The switch may be open when the temperature sensor detects that the temperature of the cell is below the maximum normal operating temperature.

The apparatus may further comprise a thermally controlled switching device that has a positive temperature coefficient and that is electrically connected in series between a voltage source of the battery cell and one of the terminals of the battery cell.

The apparatus may comprise battery cells electrically connected in parallel, wherein each of the battery cells comprises a thermally controlled switching device that has a positive temperature coefficient and that is electrically connected in series between a voltage source of the battery cell and one of the terminals of the battery cell.

The thermally controlled switching device may have a switch temperature that exceeds the maximum normal operating temperature of the cell in which the thermally controlled switching device is contained.

The thermally controlled switching device may comprise a polymeric positive temperature coefficient device, a semiconductor sensor, a resistance thermometer, a resistance temperature detector, a thermocouple, a thermopile, an infrared sensor, a thermistor, or a non-resettable fuse.

The apparatus may further comprise a comparator having an input driven by the temperature sensor and an output that drives the switch.

The apparatus may further comprise a processor having an input driven by the temperature sensor and an output that drives the switch; and a non-transitory computer readable medium, communicatively coupled to the processor, and having encoded thereon program code that causes the processor to perform a method comprising (i) determining the temperature of the cell from the temperature sensor; and (ii) when the temperature of the cell exceeds the maximum normal operating temperature, decreasing the state of charge (“SOC”) of the cell to a safe SOC.

The battery cell may comprise part of one of multiple series elements electrically connected in series, wherein each of the series elements comprises additional battery cells electrically connected in parallel.

The apparatus may further comprise additional temperature sensors positioned to measure temperatures of at least some of the additional battery cells, wherein the additional temperature sensors are communicatively coupled to the processor.

When the temperature of the cell exceeds a self-heating temperature of the cell, the processor may decrease the SOC to a minimum SOC of the cell.

When the temperature of the cell exceeds a warning temperature of the cell that is between the maximum normal operating temperature and the self-heating temperature, the processor may decrease the SOC to be above the minimum SOC and below a maximum SOC of the cell.

According to another aspect, there is provided a battery pack comprising battery cells electrically connected in parallel with each other, wherein each of the battery cells comprises a thermally controlled switching device that has a positive temperature coefficient and that is electrically connected in series between a voltage source of the battery cell and a terminal of the battery cell.

The thermally controlled switching device may comprise a polymeric positive temperature coefficient device, a semiconductor sensor, a resistance thermometer, a resistance temperature detector, a thermocouple, a thermopile, an infrared sensor, a thermistor, or a non-resettable fuse.

According to another aspect, there is provided a method for inhibiting thermal runaway of a battery cell, the method comprising determining the temperature of the cell; and when the temperature of the cell exceeds a maximum normal operating temperature of the cell, decreasing the SOC of the cell to a safe SOC.

The battery cell may comprise part of one of multiple series elements electrically connected in series, wherein each of the series elements comprises additional battery cells electrically connected in parallel.

When the temperature of the cell exceeds a self-heating temperature of the cell, the method may further comprise decreasing the SOC to a minimum SOC of the cell.

The method may further comprise when the temperature of the cell exceeds a warning temperature of the cell that is between the maximum normal operating temperature and the self-heating temperature, decreasing the SOC to be above the minimum SOC and below a maximum SOC of the cell.

According to another aspect, there is provided a non-transitory computer readable medium having encoded thereon statements and instructions to cause a processor to perform any aspects of the foregoing method.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a graph showing temperature and heating rate of a lithium ion battery cell over time according to the prior art, with the battery cell eventually experiencing thermal runaway.

FIGS. 2 and 3 are schematics of apparatuses for inhibiting thermal runaway of a battery cell, according to two different embodiments.

FIG. 4 is a schematic of a system for inhibiting thermal runaway of a battery cell, according to another embodiment.

FIG. 5 is a flowchart showing a method for inhibiting thermal runaway of a battery cell, according to another embodiment.

FIG. 6 is a schematic of an example battery pack to which various embodiments may be applied.

### DETAILED DESCRIPTION

Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description is intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.

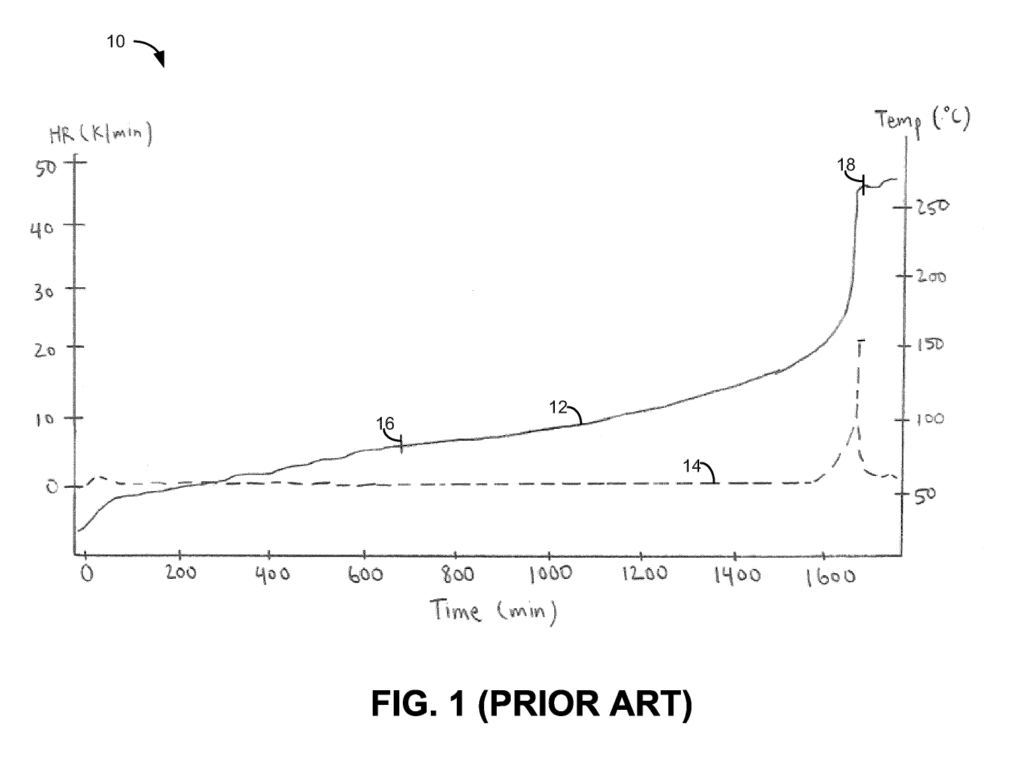

As shown in FIG. 1, a battery cell experiences a period of self-heating prior to experiencing thermal runaway. The rate at which self-heating occurs is directly proportional to the following:
1. the battery cell's state of charge (SOC), expressed as a percentage of the battery cell's maximum SOC;
2. the battery cell's capacity;
3. the battery cell's external current discharge rate, which is the rate at which the battery cell is discharging current from its terminals; and
4. the number of battery cells connected in parallel to the battery cell that is experiencing self-heating, since energy is shared between battery cells connected in parallel.

The embodiments described herein are directed at inhibiting thermal runaway by inhibiting self-heating. The temperature of the battery cell is measured using a temperature sensor to determine whether the battery cell has begun self-heating and, if so, to estimate its severity. If the battery cell is determined to be self-heating, the battery cell is discharged to reduce its SOC and to reduce the rate of self-heating or to stop the self-heating altogether.

The example embodiments below focus on various lithium ion battery chemistries. Example lithium ion battery chemistries include lithium cobalt oxide (LiCoO₂), lithium iron phosphate (LFP), lithium manganese dioxide (LMO), lithium nickel manganese cobalt (NMC), lithium nickel cobalt oxide (NCO), and lithium titanate (LTO). The example embodiments below also may be applied to battery cells packaged in different styles. Example packaging styles include cylindrical jelly roll (liquid and polymer gel electrolytes), prismatic (liquid electrolyte), and pouch (liquid and polymer gel electrolytes for a single layer electrode, and liquid electrolyte for a multi-layered electrode). Example capacities for a single battery cell range, for example, from 50 mAh to 250 Ah.

While the example embodiments below focus on lithium ion batteries, alternative embodiments (not depicted) may be used in conjunction with battery cells of different chemistries. Similarly, alternative embodiments (not depicted) may be directed at battery cells having capacities and packaging styles different from those listed above.

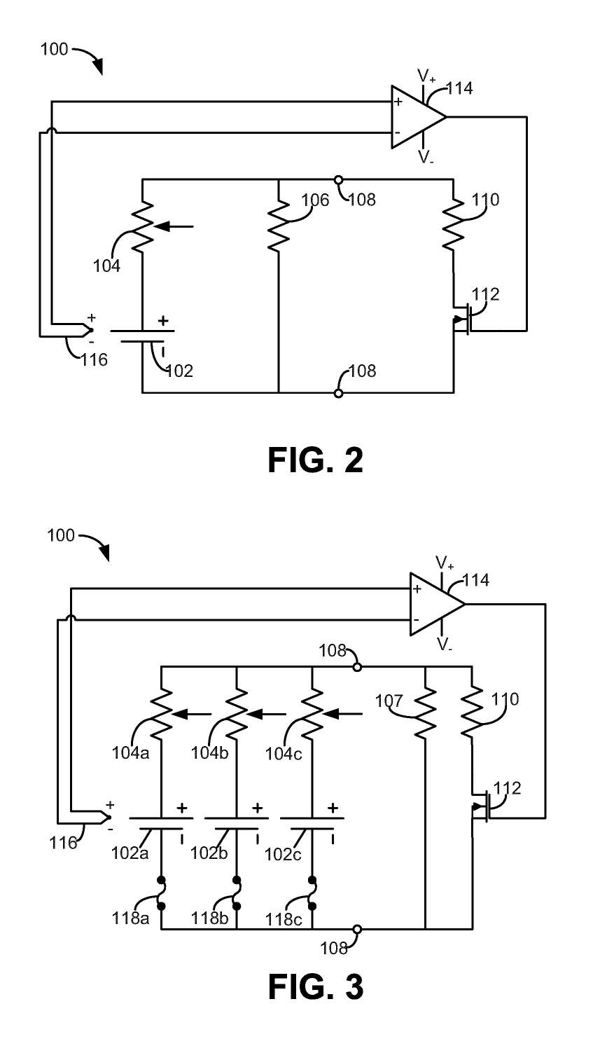

Referring now to FIG. 2, there is shown a schematic of an apparatus 100 for inhibiting thermal runaway of a battery cell, according to one embodiment. The battery cell is modeled as comprising a voltage source 102 electrically connected in series with the battery cell's internal resistance 104, which can vary depending on factors such as the load to which the battery cell is connected. The battery cell also comprises a pair of terminals 108 and, in the case of FIG. 2, suffers from an internal short circuit that is modeled as a resistance 106 (hereinafter “internal short resistance 106”) connected across the terminals 108.

The apparatus 100 further comprises a discharge circuit comprising a resistive load 110 and a transistor 112 connected in series across the terminals 108. The discharge circuit may comprise part of cell balancing circuitry electrically coupled to the battery cell; alternatively, the discharge circuit may be independent from the cell balancing circuitry, which may permit the discharge circuit to discharge the battery cell at a higher rate than would be possible if the cell balancing circuitry were used for discharge. While the transistor 112 is shown as being a MOSFET, in alternative embodiments the transistor 112 may be another suitable type of transistor, such as a BJT or IGBT, or more generally any suitable type of switching device, such as a mechanical relay or switch (e.g. a contactor).

Also comprising part of the apparatus 100 are a temperature sensor in the form of a thermocouple 116 having positive and negative terminals, and an operational amplifier in an open-loop configuration whose non-inverting and inverting inputs are connected to the thermocouple's 116 positive and negative terminals, respectively (the operational amplifier is hereinafter the “comparator 114”). The comparator 114 is powered by positive and negative voltage supplies, which are respectively labeled in FIG. 2 as V₊ and V₋. The positive voltage supply is sufficient to turn on the transistor 112, and the comparator's 114 output is connected to the transistor's 112 gate. The thermocouple 116 is configured to output a positive voltage when the temperature of the battery cell exceeds a maximum normal operating temperature of the battery cell, which in the example of FIG. 2 is 60° C. The maximum normal operating temperature of the battery cell may, however, vary with cell chemistry; for example, in one alternative embodiment, the maximum normal operating temperature of the battery cell is 70° C. The thermocouple 116 is placed in any location that permits it to accurately measure the temperature of the battery cell; for example, the thermocouple 116 may be placed within the battery cell or adjacent to the battery cell.

While the temperature sensor in FIG. 2 is the thermocouple 116, in alternative embodiments the temperature sensor may be a different but still suitable type of sensor, such as a thermopile, a resettable fuse, a thermistor, or a semiconductor sensor.

In FIG. 2, when the battery cell is at or below its maximum normal operating temperature, the thermocouple 116 drives the comparator 114 low and the transistor 112 doesn't conduct current. However, notwithstanding this the internal short causes current to flow within the battery cell and heat is consequently generated as a result of the current being impeded by the internal resistance 104 and, to a greater degree, by the internal short resistance 106, with the result being self-heating. When the temperature of the battery cell exceeds the maximum normal operating temperature, charging of the battery cell is stopped and the thermocouple 116 drives the output of the comparator 114 high, which turns on the transistor 112. Current consequently flows through the terminals 108 and the resistive load 110, reducing the battery cell's SOC and the rate of self-heating. If the battery cell's SOC is discharged to its lowest permitted value (e.g. 10%), self-heating may be stopped. If self-heating does stop and the temperature of the battery cell drops below its maximum normal operating temperature, the thermocouple 116 again drives the comparator's 114 output low, which shuts off the transistor 112.

Referring now to FIG. 3, there is shown a schematic of another embodiment of the apparatus 100 for inhibiting thermal runaway of the battery cell. The apparatus 100 shown in FIG. 3 is identical to that shown in FIG. 2 except for the following:
1. instead of a single battery cell, the apparatus 100 comprises three battery cells connected in parallel: a first battery cell comprising a first voltage source 102a connected in series with a first internal resistance 104a, a second battery cell comprising a second voltage source 102b connected in series with a second internal resistance 104b, and a third battery cell comprising a third voltage source 102c connected in series with a third internal resistance 104c;
2. instead of an internal short causing self-heating, an external short modeled by a resistor 107 (“external short resistance 107”) connected across the terminals 108 causes self-heating; and
3. connected to the anode of each of the first through third voltage sources 102a-c are first through third polymeric positive temperature coefficient devices 118a-c (hereinafter “PTCs 118a-c”), respectively.

A PTC is a thermally activated device that operates in a low impedance states (e.g. the PTC has an impedance of <0.03Ω) when used in normal temperatures (e.g. ˜23° C.) and a high impedance state (e.g. the PTC has an impedance of >100Ω) when used in high temperatures (e.g. ˜100° C.). The temperature at which the PTCs 118a-c transition between their low and high impedance states is known as their “switch temperature”. The PTCs 118a-c may be, for example, the MF-SVS line of PTCs from Bourns®, Inc. Different types of PTCs have different switch temperatures; example switch temperatures include 85° C. and 150° C.

The apparatus 100 of FIG. 3 operates in a manner similar to the apparatus 100 of FIG. 2. In FIG. 3, when the battery cells operate at or below the normal operating temperature, the thermocouple 116 drives the comparator 114 low and no current flows through the load resistance 110. However, when the temperature of any one or more of the three battery cells exceeds the normal operating temperature, which in FIG. 3 would occur because of current through the external short, the thermocouple 116 drives the comparator's 114 output high, which turns the transistor 112 on and permits current to flow through the load resistance 110. As described above in respect of FIG. 2, this inhibits, self-heating of the battery cells.

In the event self-heating is not sufficiently inhibited by the discharge circuitry alone and the temperature of any one or more of the battery cells exceeds the switch temperature of the PTCs 118a-c, the PTCs 118a-c for those battery cells will transition to their high impedance state. This electrically isolates those battery cells from the remainder of the battery cells connected to it in parallel, which further inhibits self-heating. Instead of the PTCs 118a-c, any suitable thermally controlled switching device having a positive temperature coefficient may be used; these thermally controlled switching devices comprise temperature sensors such as semiconductor sensors (whether voltage output, current output, resistance output, digital output, or simple diode types of semiconductor sensors), resistance thermometers/resistance temperature detectors, thermocouples, thermopiles, infrared sensors, thermistors, and non-resettable fuses. Some of these temperature sensors, such as thermistors and non-resettable fuses, inherently increase in resistance as temperature increases, permitting them to be used in place of the PTCs 118a-c without any ancillary switching circuitry. Others of these thermal measurement devices, such as voltage output semiconductor sensors and thermocouples, are used to drive switching circuitry to act as an open circuit when the temperature exceeds a safe operating threshold.

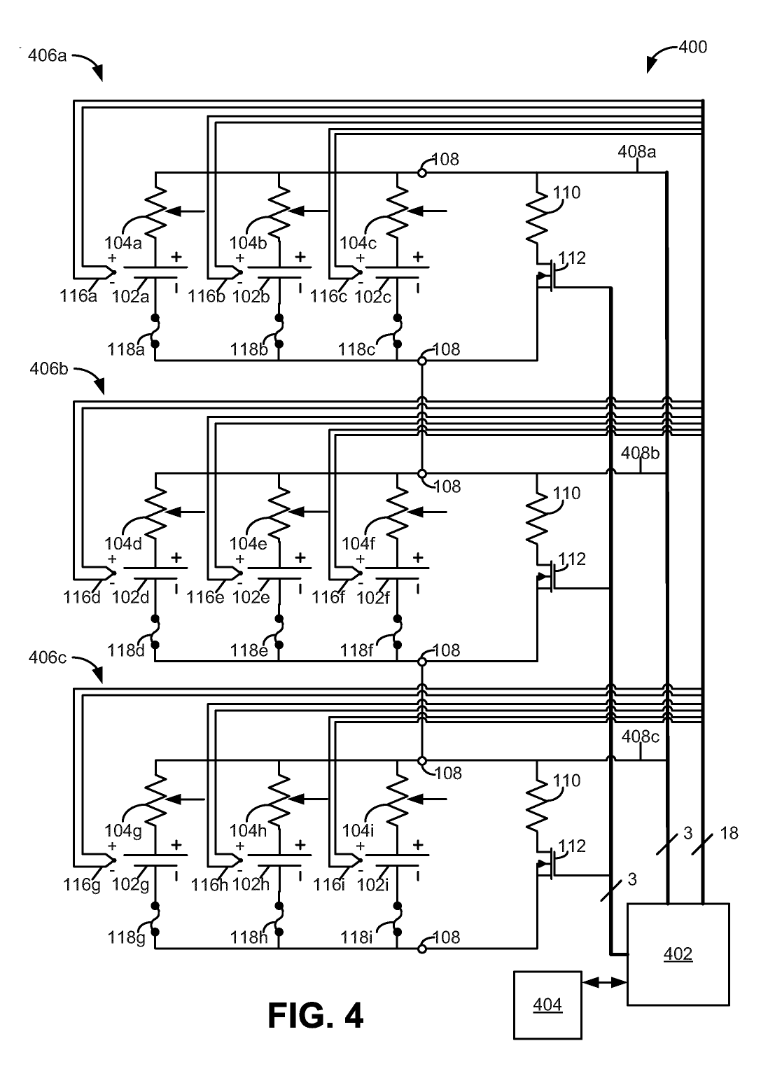

Referring now to FIG. 4, there is shown a schematic of a system 400 for inhibiting thermal runaway of the battery cells, according to another embodiment. The system 400 comprises first through third series elements 406a-c. Each of the series elements 406a-c comprises three battery cells, with the battery cells of the first series element 406a being modeled by voltage sources 102a-c in series with internal resistances 104a-c, respectively, the battery cells of the second series element 406b being modeled by voltage sources 102d-f in series with internal resistances 104d-f, respectively, and the battery cells of the third series element 406c being modeled by voltage sources 102g-i in series with internal resistances 104g-i, respectively. As with the apparatus 100 of FIG. 3, each of the battery cells is connected in series with a PTC; in FIG. 4, this is shown by connecting PTCs 118a-i in series with the voltage sources 102a-i, respectively. Each of the series elements 406a-c comprises a pair of terminals 108 and is electrically connected in series with the other of the series elements 406a-c via its terminals 108.

Each of the series elements 406a-c is identical to the embodiment of the apparatus 100 of FIG. 3 except for the following:
1. each of the series elements 406a-c comprises three of the thermocouples 116, with the first series element 406a comprising first through third thermocouples 116a-c, the second series element 406b comprising fourth through sixth thermocouples 116d-f, and the third series element 406c comprising seventh through ninth thermocouples 116g-i;
2. the series elements 406a-c do not comprise the comparator 114;
3. instead of the thermocouples 116a-i sending output signals to the comparator 114, they are directly communicative with a processor 402, as discussed in further detail below; and
4. no internal or external short is shown affecting any of the battery cells in FIG. 4.

In the embodiment of FIG. 4, the thermocouples 116a-i are each capable of measuring temperatures of at least between 55° C. and 90° C. Each of the thermocouples 116a-i is positioned to measure the temperature of one of the battery cells; for example, each of the thermocouples 116a-i may be positioned within the packaging of a different one of the battery cells.

The system 400 further comprises a processor 402 communicatively coupled to the output of each of the thermocouples 116a-i and to the gates of each of the transistors 112 of the series elements 406a-c. The processor 402 includes an analog-to-digital converter to digitize the signals output by the thermocouples 116a-i. First through third current sensing lines 408a-c electrically connect three of the processor's 402 input pins to the series elements 406a-c. More particularly, first through third current sensing lines 408a-c are electrically connected directly to the end of the resistive load 110 of the first through third series elements 406a-c, respectively, that is opposite the transistor 112. When the transistor 112 for any of the series elements 406a-c is on, the current sensing line 408a-c directly connected to that element 406a-c permits the processor 402 to measure the voltage across the resistive load 110 of that element 406a-c, which permits the processor 402 to determine the current flowing through the resistive load 110 using Ohm's Law.

While the thermocouples 116a-i are directly connected to the processor 402 in FIG. 4, in an alternative embodiment (not shown) they are connected to the processor 402 via a multiplexer whose selection line is connected to one of the processor's 402 output pins and that is accordingly controlled by the processor 402. Cell monitoring circuitry (not shown) is also communicatively coupled to the processor 402 and permits the processor 402 to know the SOC of each of the battery cells. The system 400 further comprises a non-transitory computer readable medium 404 that is communicatively coupled to the processor 402 and has encoded on it program code, executable by the processor 402, to cause the processor 402 perform a method for inhibiting thermal runaway.

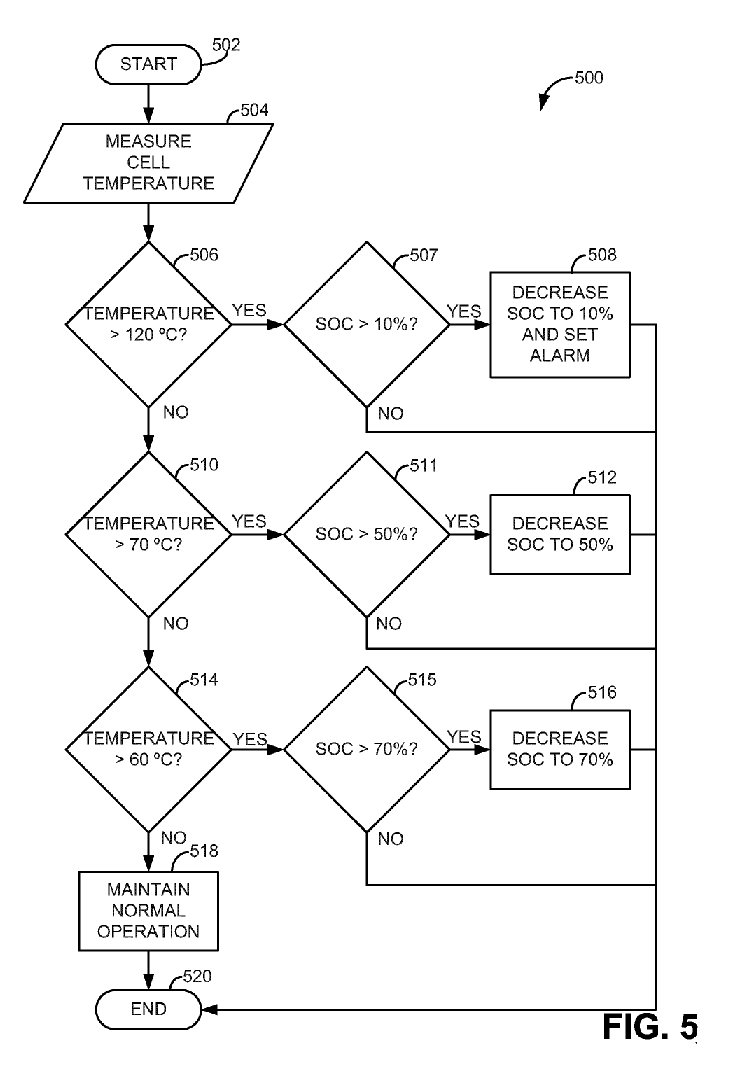

A flowchart of one example method 500 for inhibiting thermal runaway that may be encoded on to the computer readable medium 404 is shown in FIG. 5. The processor 402 performs the method 500 independently for each of the battery cells of FIG. 4; in this particular embodiment, each of the battery cells is a 1.75 Ah cell charging at 1 C, discharging at 1 C, and operating between minimum and maximum SOCs of 10% and 90% SOC, respectively; these cells may be used, for example, in a Dow Kokam™ 75 Ah battery pack. In FIG. 5, the processor 402 begins performing the method 500 at block 502 and proceeds to block 504 where it measures the temperature of the battery cell using the thermopile 117. At block 506, the processor 402 determines whether the temperature exceeds a maximum operating temperature, which in the example of FIG. 5 is 120° C., which is the self-heating temperature in this example. If the temperature of the battery cell exceeds its self-heating temperature, the processor 402 proceeds to block 507 where it determines whether the SOC of the battery cell is above its minimum SOC (10% in the embodiment of FIG. 5); if yes, the processor 402 proceeds to block 508 and immediately decreases the SOC for that battery cell to a safe SOC, which when the measured temperature is at or above the self-heating temperature is its minimum SOC, as quickly as possible. The processor 402 also flags an alarm to notify a technician that the battery cell reached its self-heating temperature. The SOCs of all the other cells in the same series element 406a-c as the overheated cell are similarly reduced if the PTCs 118a-i connected in series with those other cells remain in their low impedance state. The processor 402 then proceeds to block 520, where the method 500 ends. Alternatively, if at block 507 the processor 402 determines that the battery cell is below its minimum SOC, the processor 402 bypasses block 508 and ends the method 500 by proceeding directly to block 520.

If the processor 402 determines at block 506 that the battery cell has not exceeded 120° C., it proceeds to block 510 where it determines whether the battery cell is between 70° C. and 120° C. If yes, the processor 402 proceeds to block 511 where it determines whether the SOC of the battery cell is above 50%. If yes, the processor 402 proceeds to block 512 where it decreases the SOC of the battery cell to a safe SOC, which when the measured temperature is between 70° C. and 120° C. is 50%. Reducing the SOC to 50% inhibits the battery cell's progression to its self-heating temperature. Following reducing the SOC, the processor 402 proceeds to block 520 where the method 500 ends. 70° C. in this example is a warning temperature that indicates the battery cell is operating significantly above its normal operating temperature, notwithstanding that it has not yet reached its self-heating temperature. Alternatively, if at block 511 the processor 402 determines that the battery cell's SOC is below 50%, the processor 402 bypasses block 512 and ends the method 500 by proceeding directly to block 520.

If the processor 402 determines at block 510 that the battery cell has not exceeded 70° C., it proceeds to block 514 where it determines whether the battery cell is between 60° C. and 70° C. If yes, the processor 402 proceeds to block 515 where it determines whether the SOC of the battery cell is above 70%. If yes, the processor 402 proceeds to block 516 where it decreases the SOC of the battery cell to a safe SOC, which when the measured temperature is between 60° C. and 70° C. is 70%. Reducing the SOC to 70% inhibits the battery cell's progression to its self-heating temperature. Following reducing the SOC, the processor 402 proceeds to block 520 where the method 500 ends. In this example, 60° C. is the maximum normal operating temperature of the battery cell, and the battery cell's exceeding its maximum normal operating temperature may be a precursor to thermal runaway notwithstanding the risk is not yet as high as when the battery cell is at the warning or self-heating temperatures. Alternatively, if at block 515 the processor 402 determines that the battery cell's SOC is below 70%, the processor 402 bypasses block 516 and ends the method 500 by proceeding directly to block 520.

If the processor 402 determines at block 514 that the battery cell has not exceeds 60° C., then the battery cell's temperature is not indicative of potential or imminent self-heating or thermal runaway. The processor 402 accordingly proceeds to block 518 where it maintains normal operation of the battery cell, following which it proceeds to block 520 where the method 500 ends.

While in FIG. 5 the self-heating temperature is 120° C., the warning temperature is 70° C., and the maximum normal operating temperature is 60° C., in alternative embodiments any one or more of these temperatures may vary with factors such as cell packaging and chemistry. For example, in one alternative embodiment (not depicted), the maximum normal operating temperature is 70° C., the warning temperature is 90° C., and the self-heating temperature is 120° C. Furthermore, in alternative embodiments (not depicted), the method 500 may include multiple warning temperatures, with the SOC to which the battery cell is discharged varying inversely with the magnitude of the warning temperature.

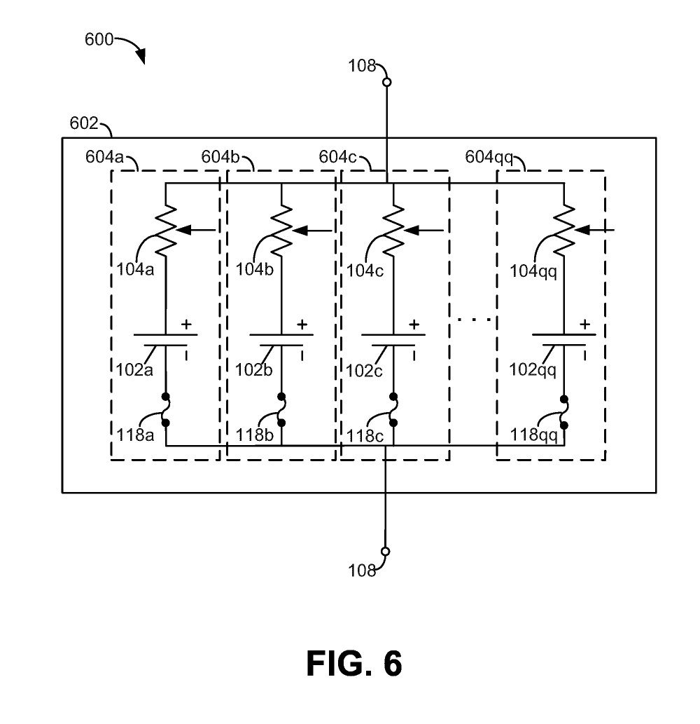

Referring now to FIG. 6, there is shown an example battery pack 600 to which the various embodiments herein may be applied. The battery pack 600 is a Dow Kokam™ 75 Ah battery pack comprising forty-three battery cells 604a-qq electrically connected in parallel and contained within a casing 602. The first battery cell 604a comprises a first voltage source 102a connected in series with a first internal resistance 104a and a first PTC 118a, the second battery cell 604b comprises a second voltage source 102b connected in series with a second internal resistance 104b and a second PTC 118b, and so on, with the last battery cell 604qq being the forty-third battery cell, which comprises a forty-third voltage source 102qq connected in series with a forty-third internal resistance 104qq and a forty-third PTC 118qq. While not shown in FIG. 6, the apparatus 100 may be used in conjunction with any one or more cells of the battery pack 600 to lower the SOC of the battery cells in order to inhibit thermal runaway. Similarly, the battery pack 600 may be used as one of the series elements 406a-c in the system 400 of FIG. 4.

Each of the PTCs 118a-qq is contained within the packaging of one of the battery cells 604a-qq and comprises first and second terminals: its first terminal is electrically connected in series to a negative terminal of one of the voltage sources 102a-qq, and its second terminal is connected to the second terminals of each of the other PTCs 118a-qq, which are thereby commonly connected together and connected to one of the terminals 108 of the battery pack 600. The effect of positioning each of the PTCs 118a-qq within the packaging of one of the battery cells 604a-qq is that should any of the PTCs 118a-qq transition to their high impedance state as a result of a temperature increase, the voltage sources 102a-qq to which those tripped PTCs 118a-qq are connected in series will be electrically isolated from all the other voltage sources 102a-qq in the battery pack 600. This limits the amount of energy that can be used to fuel a thermal runaway and decreases the rates at which one or both of the battery cells' 604a-qq temperatures and pressures increase.

In the embodiment of FIG. 6, the example switch temperature of the PTCs 118a-qq is 150° C., while the maximum normal operating temperature of the cells 604a-qq is 70° C. In alternative embodiments (not depicted), however, the difference between the maximum normal operating temperature and the PTCs' 118a-qq switch temperature may be more or less than the 80° C. of this example, and different PTCs 118a-qq may have different switch temperatures.

The processor 402 used in the foregoing embodiments may be, for example, a microprocessor, microcontroller, programmable logic controller, field programmable gate array, or an application-specific integrated circuit. Examples of the computer readable medium 404 are non-transitory and include disc-based media such as CD-ROMs and DVDs, magnetic media such as hard drives and other forms of magnetic disk storage, semiconductor based media such as flash media, random access memory, and read only memory.

For the sake of convenience, the example embodiments above are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

FIG. 5 is a flowchart of an example method. Some of the blocks in the flowchart may be performed in an order other than that which is described. Also, it should be appreciated that not all of the blocks described in the flowchart are required to be performed, that additional blocks may be added, and that some of the illustrated blocks may be substituted with other blocks.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. An apparatus for inhibiting thermal runaway of a battery cell, the apparatus comprising:
a temperature sensor positioned to measure a temperature of the cell; and
a discharge circuit, comprising a switch and a resistive load electrically coupled in series across terminals of the cell, wherein the switch is closed when the temperature sensor detects that the temperature of the cell has exceeded a maximum normal operating temperature.

2. The apparatus of claim 1 wherein the switch is open when the temperature sensor detects that the temperature of the cell is below the maximum normal operating temperature.

3. The apparatus of claim 1 further comprising a thermally controlled switching device that has a positive temperature coefficient and that is electrically connected in series between a voltage source of the battery cell and one of the terminals of the battery cell.

4. The apparatus of claim 1 wherein the apparatus comprises battery cells electrically connected in parallel, and wherein each of the battery cells comprises a thermally controlled switching device that has a positive temperature coefficient and that is electrically connected in series between a voltage source of the battery cell and one of the terminals of the battery cell.

5. The apparatus of claim 3 wherein the thermally controlled switching device has a switch temperature that exceeds the maximum normal operating temperature of the cell in which the thermally controlled switching device is contained.

6. The apparatus of claim 3 wherein the thermally controlled switching device comprises a polymeric positive temperature coefficient device, a semiconductor sensor, a resistance thermometer, a resistance temperature detector, a thermocouple, a thermopile, an infrared sensor, a thermistor, or a non-resettable fuse.

7. The apparatus of claim 1 further comprising a comparator having an input driven by the temperature sensor and an output that drives the switch.

8. The apparatus of claim 1 further comprising:
a processor having an input driven by the temperature sensor and an output that drives the switch; and
a non-transitory computer readable medium, communicatively coupled to the processor, and having encoded thereon program code that causes the processor to perform a method comprising:
determining the temperature of the cell from the temperature sensor; and
when the temperature of the cell exceeds the maximum normal operating temperature, decreasing the state of charge (“SOC”) of the cell to a safe SOC.

9. The apparatus of claim 8 wherein the battery cell comprises part of one of multiple series elements electrically connected in series, wherein each of the series elements comprises additional battery cells electrically connected in parallel.

10. The apparatus of claim 9 further comprising additional temperature sensors positioned to measure temperatures of at least some of the additional battery cells, wherein the additional temperature sensors are communicatively coupled to the processor.

11. The apparatus of claim 9 wherein when the temperature of the cell exceeds a self-heating temperature of the cell, decreasing the SOC to a minimum SOC of the cell.

12. The apparatus of claim 11 wherein when the temperature of the cell exceeds a warning temperature of the cell that is between the maximum normal operating temperature and the self-heating temperature, decreasing the SOC to be above the minimum SOC and below a maximum SOC of the cell.

13. A battery pack comprising battery cells electrically connected in parallel with each other, wherein each of the battery cells comprises a thermally controlled switching device that has a positive temperature coefficient and that is electrically connected in series between a voltage source of the battery cell and a terminal of the battery cell.

14. The battery pack of claim 13 wherein the thermally controlled switching device comprises a polymeric positive temperature coefficient device, a semiconductor sensor, a resistance thermometer, a resistance temperature detector, a thermocouple, a thermopile, an infrared sensor, a thermistor, or a non-resettable fuse.

15. A method for inhibiting thermal runaway of a battery cell, the method comprising:
determining the temperature of the cell; and
when the temperature of the cell exceeds a maximum normal operating temperature of the cell, decreasing the state of charge (“SOC”) of the cell to a safe SOC.

16. The method of claim 15 wherein the battery cell comprises part of one of multiple series elements electrically connected in series, wherein each of the series elements comprises additional battery cells electrically connected in parallel.

17. The method of claim 15 further comprising when the temperature of the cell exceeds a self-heating temperature of the cell, decreasing the SOC to a minimum SOC of the cell.

18. The method of claim 17 further comprising when the temperature of the cell exceeds a warning temperature of the cell that is between the maximum normal operating temperature and the self-heating temperature, decreasing the SOC to be above the minimum SOC and below a maximum SOC of the cell.

19. A non-transitory computer readable medium having encoded thereon statements and instructions to cause a processor to perform a method for inhibiting thermal runaway of a battery cell, the method comprising:
determining the temperature of the cell; and
when the temperature of the cell exceeds a maximum normal operating temperature of the cell, decreasing the state of charge (“SOC”) of the cell to a safe SOC.
